(19) United States
(12) Patent Application Publication
(10) Pub. No.: US 2009/0054112 A1
(43) Pub. Date: Feb. 26, 2009

(54) DISPLAY FOR PORTABLE ELECTRONIC DEVICE

(75) Inventors: ADAM CYBART, MCHENRY, IL (US); ROGER W. ADY, CHICAGO, IL (US); CHRISTOPHER A. ARNHOLT, HIGHLAND PARK, IL (US); DAVID B. CRANFILL, ANTIOCH, IL (US); WILLIAM R. GROVES, NAPERVILLE, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/844,524

(22) Filed: Aug. 24, 2007

(51) Int. Cl. H04M 1/00

(52) U.S. Cl. 455/575.3

(57) ABSTRACT

A portable electronic device (200) including a housing having a movable housing portion in the form of a flip, rotating blade or slider portion. A controller is electrically coupled to a plurality of light shutter portions in the movable housing portion, wherein the controller independently configuring each light shutter portion between first and second light transmitting states based upon input from a sensor, an application or based upon the configuration of the housing. The shutter portions may obscure or reveal an underlying display or inputs.

### FIELD OF THE DISCLOSURE

The present disclosure relates generally to display technology, and more specifically to display interfaces for electronic devices, for example, for wireless communication handsets.

### BACKGROUND

Mobile telephones including tablet devices and personal digital assistants (PDAs) among other devices having a movable housing portion, for example, a flip, that covers a display are known generally. In some devices, the movable housing portion is clear or opaque and functions at least partially to protect the display when closed. Flip type housings may also form an ear-piece containing an audio speaker for use when the flip is opened.

U.S. Pat. No. 6,662,244 to Takahashi entitled “Information Terminal” discloses a portable telephone having first and second hinged housing portions wherein the first housing portion has a display section and the second housing portion has an input/display section comprising a touch panel bonded to a transmission type LCD display. In the opened state, the input/display section of the second housing portion functions as a display and input device. In the closed state, the input/display section of the second housing portion overlaps the display section of the first housing portion. In the closed state, the input section of the second housing portion becomes inoperable and the LCD display becomes transparent to permit observation of the display section of the first housing portion.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a portable electronic device having a movable housing portion.

FIG. 2 is a schematic block diagram of an electronic device.

FIG. 3 is a sectional view of a portable electronic device having hinged housing portions.

FIG. 4 is a plan view of an electronic device wherein a light shutter portion is in a blocking state.

FIG. 5 is a plan view of an electronic device wherein a light shutter portion is in a transmitting state.

FIG. 6 is a plan view of an electronic device wherein a light shutter portion is in a partially blocking/partially transmitting state.

FIG. 7 is a plan view of an electronic device wherein a light shutter portion is in another partially blocking/partially transmitting state.

FIG. 8 is a plan view of an electronic device wherein a light shutter portion is in another partially blocking/partially transmitting state.

FIG. 9 is a plan view of an electronic device wherein a light shutter portion is in yet another partially blocking/partially transmitting state.

FIG. 10 is a plan view of an electronic device wherein a light shutter portion is in a blocking state.

FIG. 11 is a plan view of an electronic device wherein a light shutter portion is in a transparent state.

FIG. 12 is a plan view of an electronic device wherein a light shutter portion is in a partially blocking/partially transmitting state.

### DETAILED DESCRIPTION

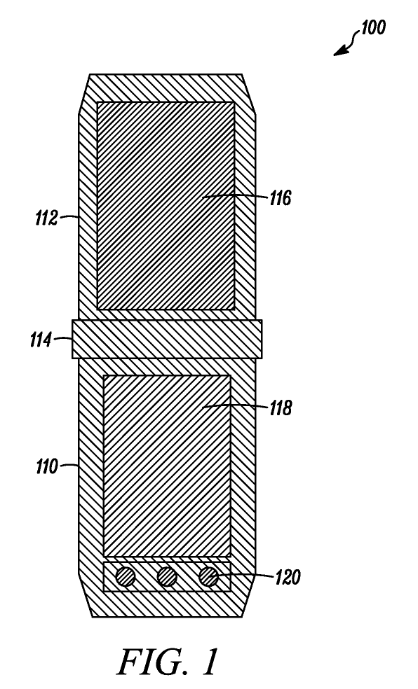

In FIG. 1, the portable electronic device 100 comprises a housing 110 having a movable housing portion 112 pivotally coupled thereto by a hinge 114. The moving portion 112 is in the exemplary form of a flip and is positionable between first and second configurations. In one configuration, the flip is opened relative to the housing as illustrated in FIG. 1. In the other configuration, illustrated in FIG. 3, the flip 112 is closed relative to the housing 110. In another embodiment, the movable housing portion is a sliding member that slides relative to the housing between the first and second configurations. In yet another embodiment, the movable housing portion is a blade that rotates relative to the housing between the first and second configurations. In these and other devices having a movable housing portion, the movable housing portion may also be configurable in intermediate configurations between the opened and closed positions. In one embodiment, the portable electronic device is a wireless communication device like a cell phone. In other embodiments, the device is a PDA, or a portable media device or some other handheld electronic device.

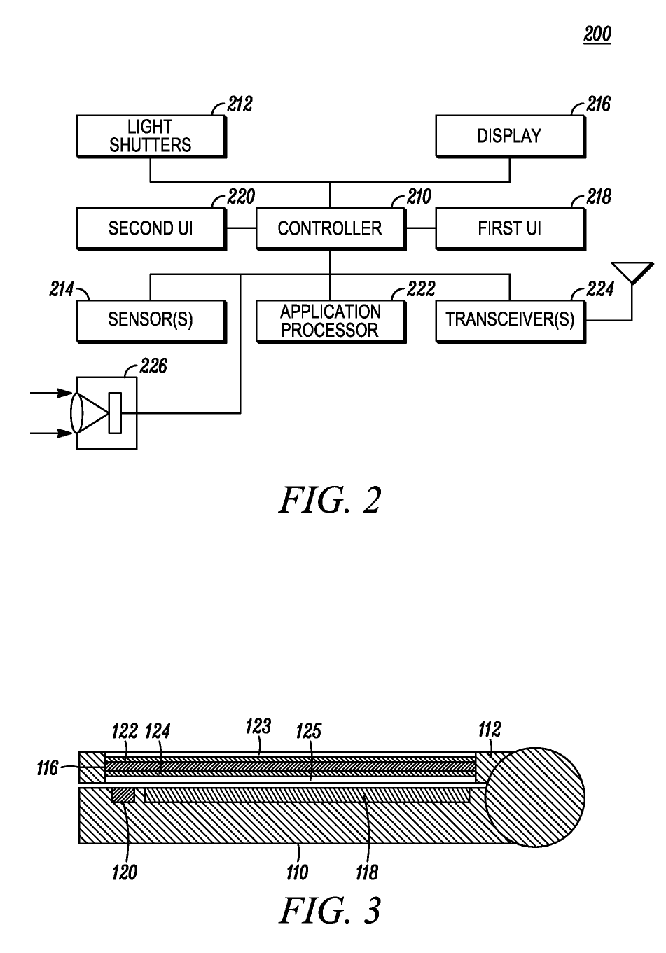

FIG. 2 illustrates a schematic block diagram of an exemplary device 200 comprising a controller 210 electrically coupled to a light shutter panel 211 comprising two or more light shutter portions, which may be configured in an array or in some other arrangement. The light shutter portions may comprise a polymer dispersed liquid crystal (PDLC), or a cholesteric liquid crystal, or a twisted-nematic liquid crystal (TNLC) or some other material that changes states in a manner that controls the transmission or reflection of incident light. In one embodiment, the controller is configured to independently control each of the plurality of light shutter portions between first and second light transmitting states wherein one state permits the transmission of more light through the panel than the other state. More generally, the shutter portions may also have multiple states. The controller may be embodied as a digital controller programmed by software or firmware stored in a memory device. In one application, a first state permits light transmission through the movable housing portion in which the shutter is disposed and a second state obstructs the transmission of light through the movable housing portion.

In FIG. 2, the device 200 includes a shutter controlling sensor 214 electrically coupled to the controller 210 wherein the controller is configured to cause one or more shutter portions to change states in response to a signal from the sensor. In one embodiment, the shutter controlling sensor is selected from a group of sensors comprising a proximity sensor, a tactile-based sensor, and an accelerometer that provides an output based on an orientation of the portable electronic device. The controller may also activate other portions of the device in response to changes detected by the sensor. For example, the controller may enable a primary or secondary display and/or transition the device from a relatively low power state to a more active state in response to the detection of a changing condition by the sensor.

In another embodiment, the controller causes one or more shutter portions to change states based on an application running on the device. In FIG. 2, the application is run on an application processor 222 electrically coupled to the controller. In wireless communication applications, the controller may control the state of the shutter portions based upon an output from a call processor. Such an output may be generated for example, upon receipt of a call. In other embodiments, the state of the shutter portions depends upon both the configuration of the housing and on one or more applications running on the device. The controller may also configure the state of the light shutter portions based upon the configuration of the movable housing portion. In one use case, for example, the shutter portions are configured when the movable housing portion is opened or closed. More generally, the controller may configure the state of the shutter portions based upon the configuration of some other mechanical or electrical configuration of the device. A few exemplary use cases are discussed further below.

The device 200 of FIG. 2 also includes a display 216 and a first user interface 218, for example, input keys and/or a navigation pad. A second user interface 220 may be embodied as a touch screen or as some other input. For example, the display 216 may have a touch screen associated therewith. The device also includes an application processor 222. In some embodiments, the application processor is integrated with the controller. In applications where the electronic device is capable of wireless communications, the device may also include one or more wireless transmitters and/or receivers 224. Exemplary transceivers include cellular, LAN, WAN, Bluetooth, and/or IrDA transceivers among others. The device may also comprise a navigation receiver, for example a GPS receiver. Navigation and routing applications used in conjunction with the navigation receiver may also be a basis for configuring the shutter portions.

In FIGS. 1 and 3, a shutter panel 116 comprising shutter portions is disposed on the movable housing portion 112. The shutter panel shown occupies a substantial portion of the moving housing portion, though in other embodiments the shutter panel may occupy less area. In other embodiments, there may be multiple shutter panels. In FIG. 1, the housing portion includes a display 118 and input keys and/or a navigation pad 120. FIG. 3 illustrates touch sensors 122, 124 on opposite sides of the shutter panel. In other embodiments, the touch sensor may be located on only one side of the panel. The touch sensors accommodate user input when the moving housing portion is opened or closed. In some embodiments, the touch sensor may be activated and deactivated based on whether the moving housing portion is opened or closed based on input from a sensor that detects the configuration of the housing. In FIG. 3, for example, the touch sensor 122 may be enabled and the touch sensor 124 disabled when the movable housing portion 112 is closed. When the movable housing portion is opened, the touch sensor 122 may be disabled and the touch sensor 124 enabled.

In some embodiments, illustrated in FIG. 3, there may also be a protective or decorative film or lens 123, 125 disposed on each of the touch sensors or on the light shutter in the absence of touch sensors. In one embodiment, an optical film limits the angle at which light may be transmitted through the shutter panel. Such a film reduces the viewing angle through the light shutters, wherein the viewing angle is measured relative to a reference that is perpendicular to the plane of the shutter panel.

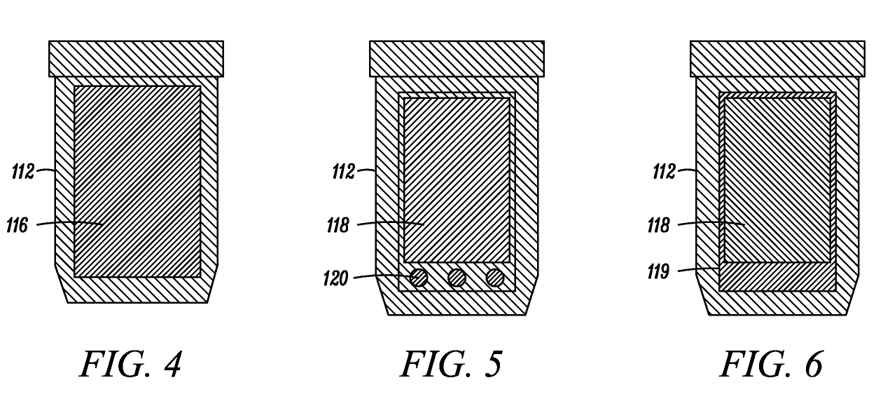

In one embodiment, the movable housing portion covers at least a portion of the housing in a least one configuration of the movable housing portion and at least a portion of the housing is concealed by one or more of the shutter portions configured in the light obstructing state when the movable housing portion covers the housing or a portion thereof. In FIG. 1, for example, the movable housing portion 112 in the opened configuration exposes the display 118 and the key pad 120. In FIG. 4, the movable housing portion 112 is in the closed configuration wherein the display and the key pad are concealed when the shutter portions of the shutter panel 116 are in the light obstructing state.

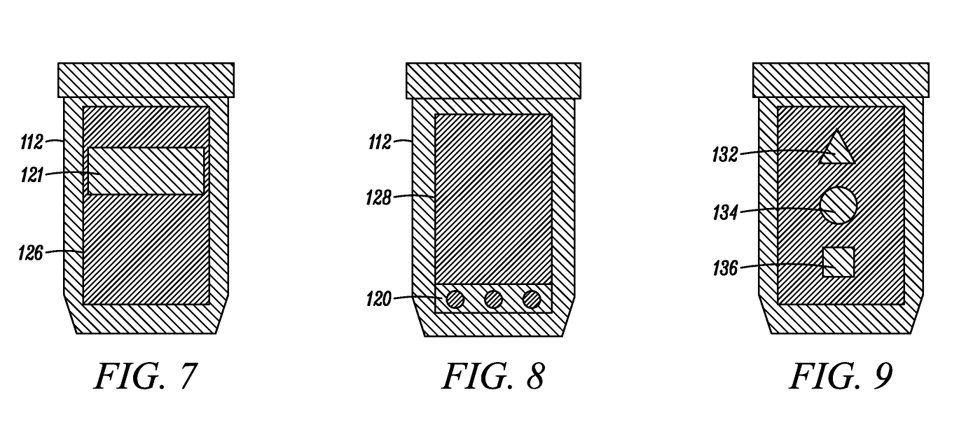

The housing or a portion thereof may also be revealed through at least one of the shutter portions configured in a light transmitting state when the movable housing portion covers the housing or a portion thereof. In FIG. 5, the movable housing portion 112 is in the closed configuration wherein the display and the key pad are exposed when the shutter portions of the shutter panel 116 are in the light transmitting state. Configuring all of the shutter portions in the light obstructing states would conceal the underlying display and keypad as illustrated in FIG. 3. In FIG. 6, the shutter panel is selectively configured so that only the display 118 is exposed by the light transmitting shutter portions when the moving housing portion is closed. In FIG. 6, the key pad is concealed by shutter portions 119 configured in a light obstructing state. In FIG. 7, the shutter panel is selectively configured so that only a portion 121 of the display is exposed by the light transmitting shutter portions when the moving housing portion is closed. In FIG. 7, the key pad and other portions of the display are concealed by shutter portions 126 configured in a light obstructing state. The exposed portion of the display may be used to display a dialed number or the number of an incoming caller. In FIG. 8, the shutter panel is selectively configured so that only the key pad 120 is exposed by the light transmitting shutter portions when the moving housing portion is closed. In FIG. 8, the display is concealed by shutter portions 128 configured in a light obstructing state.

In one use case, the shutter portions are configured to obstruct the transmission of light such that the underlying display and key pad are concealed illustrated in FIG. 4. Thereafter, in response to an event, the shutter portions are configured to permit the transmission of light thereby revealing the underlying display or portion thereof and/or revealing the underlying key pad as illustrated in FIGS. 5-9. The event could be the detection of changing condition by the sensor 214 of FIG. 2 as discussed above. In wireless telephone applications, for example, an incoming call could prompt the configuration of shutter portions to permit the transmission of light to reveal the callers name, number or other indicia displayed on the underlying display. This information could be displayed on the exposed display portions illustrated in FIGS. 5-7. In FIGS. 5 and 6, the underlying display could also display video. In FIG. 7, the underlying display could also display the multimedia tracks currently playing or tracks queued for playing.

In another embodiment, the movable housing portion includes a user interface, for example, the touch screen 122 and/or 124 illustrated in FIG. 3. In this embodiment, the controller is capable of configuring the plurality of light shutter portions to reveal a portion of the display on the housing when the movable housing portion is in the closed configuration. The display may include indicia for the user interface on the movable housing portion. The indicia may be in the form of application icons or other information, for example, an electronic phone book listing, audio and video files, documents, etc. In embodiments with a touch screen on the movable housing portion, when the shutter portions of the movable housing portion are configured to the reveal the display, the controller may configure the device to enable the user to interact with the display interface using the touch screen, for example, to start applications, select documents and files, etc. Thus the user could perform function using the touch screen that would other wise be performed directly on the underlying display.

In another embodiment where the movable housing portion includes a user interface, for example, the touch screen 122 illustrated in FIG. 3, the controller is capable of configuring the plurality of light shutter portions to conceal one or more portions of the display on the housing when the movable housing portion is in the closed configuration. In FIGS. 6 and 7, for example, the movable housing portion covers the key pad by virtue of the configuration of the shutter portions. In FIG. 6, all of the underlying display is visible but the key pad is not. In FIG. 7, only a portion of the underlying keypad is visible. More generally, however, the key pad may be obscured by a portion of the movable housing portion other than the shutter portions. Generally, the controller configures the user interface, e.g., the touchpad, of the movable housing portion to perform the function performed by the visibly obscured key pad. In one embodiment, the underlying display may provide indicia aligned with corresponding portions of the touch screen interface on the movable housing portion, wherein inputs at the touch screen execute the same functions provided by the user interface that is concealed by the moving housing portion. FIG. 9 illustrates the light shutter portions 132, 134 and 136 configured in a light transmitting state that may expose portions of the underlying display panel. As indicated, the underlying display may include indicia or icons indicative of functions performed by depressing corresponding portions of the touch screen aligned with the icons. As suggested above, the functions performed by the touch screen inputs on the movable housing portion may be the same as the function performed by the key pad covered by the movable housing portion. Thus upon closing the movable housing portion, the function performed by the concealed key pad is translated to the touch screen.

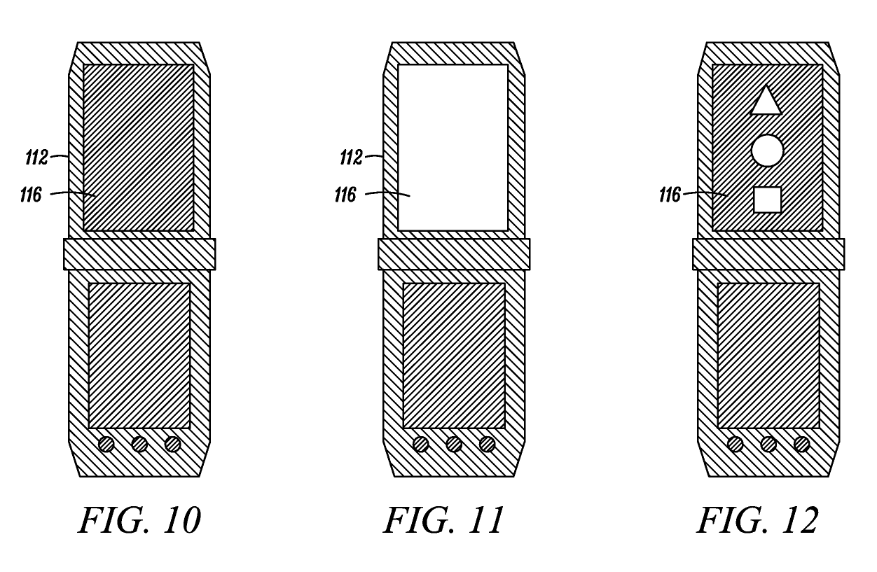

Generally either side of the movable housing portion may be configured to display an image or to reflect or diffuse light when the movable housing portion is opened or closed. When the moving housing portion is closed and the shutter panel is transparent as in FIG. 5 or 6, an image may be provided by the display. The reflection or diffusion of light may be enabled by an optical film or coating on the exposed side of the movable housing portion. In FIG. 10, the controller configures the plurality of light shutter portions of the shutter panel 116 in the light obstructing state when the movable housing portion 112 is opened. In another embodiment, illustrated in FIG. 11, the controller configures the plurality of light shutter portions of the shutter panel 116 in the light transmitting state when the movable housing portion 112 is opened.

In FIG. 12, the controller configures the plurality of light shutter portions of the shutter panel 116 to display an image when the movable housing portion 112 is opened. In FIG. 2, the device includes an image capture device 226 including a lens focused on an image sensor communicably coupled to an image engine. In this use case, when the image capture application is running and when the movable housing portion is opened, the controller configures the plurality of light shutter portions to display a view finder, e.g., a cross-hair, that is aligned with an optical path of the lens, wherein the user may focus the lens on an object for image capture using the view finder.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A portable electronic device comprising:
a housing;
a movable housing portion positionable between first and second configurations;
the movable housing portion including a plurality of light shutter portions,
a controller electrically coupled to the plurality of light shutter portions,
the controller independently configuring each light shutter portion between first and second states,
wherein the first state permits light transmission through the movable housing portion and the second state obstructs the transmission of light through the movable housing portion.

2. The device of claim 1,
a shutter controlling sensor electrically coupled to the controller, the controller causing at least some of the shutter portions to change states in response to a signal from the shutter controlling sensor,
the shutter controlling sensor selected from a group comprising: a proximity sensor, a tactile-based sensor, and an accelerometer detecting an orientation of the portable electronic device.

3. The device of claim 1, the controller causing at least some of the shutter portions to change states in response to a signal from an application running on the device.

4. The device of claim 1,
the movable housing portion covers at least a portion of the housing in a least one configuration,
at least a portion of the housing is concealed by at least one of the shutter portions configured in the light obstructing state when the movable housing portion covers at least a portion of the housing,
at least a portion of the housing is revealed through at least one of the shutter portions configured in the light transmitting state when the movable housing portion covers at least a portion of the housing.

5. The device of claim 1,
a user interface on the housing, the user interface selected from a group comprising a display and an input key,
the movable housing portion covers at least a portion of the user interface on the housing in a least one configuration,
the controller configuring the plurality of light shutter portions to conceal and reveal select portions of the user interface on the housing when the movable housing portion covers the select portions of the user interface.

6. The device of claim 5,
the user interface on the housing includes a display and an input key,
the movable housing portion covers at least a portion of the display and the input key,
the controller configuring the plurality of light shutter portions to conceal the input key and to reveal at least a portion of the display.

7. The device of claim 5,
the user interface on the housing includes a display and an input key,
the movable housing portion covers at least a portion of the display and the input key,
the controller configuring the plurality of light shutter portions to reveal the input key and to conceal at least a portion of the display.

8. The device of claim 1,
a user interface on the movable housing portion,
a display on the housing,
the movable housing portion covers at least a portion of the display on the housing in a least one configuration,
the controller capable of configuring the plurality of light shutter portions to reveal at least a portion of the display on the housing when the movable housing portion covers the revealed portion of the display,
the revealed portion of the display on the housing includes indicia for the user interface on the movable housing portion when the movable housing portion covers the revealed portion of the display.

9. The device of claim 1,
a user interface on the movable housing portion, the user interface electrically coupled to the controller,
a second user interface on the housing,
the movable housing portion covers at least a portion of the second user interface on the housing in a least one configuration,
the controller configuring the plurality of light shutter portions to conceal at least a portion of the second user interface on the housing when the movable housing portion covers the concealed portion of the second user interface,
the controller configuring the user interface to perform a function performed by the portion of the second user interface concealed.

10. The device of claim 1, the controller configuring the state of each of the light shutter portions dependent on the configuration of the movable housing portion.

11. The device of claim 10,
the first configuration of the movable housing portion is an opened configuration and the second configuration of the movable housing portion is a closed configuration,
the controller configuring the plurality of light shutter portions in the light obstructing state when the movable housing portion is in the opened configuration.

12. The device of claim 10,
the first configuration of the movable housing portion is an opened configuration and the second configuration of the movable housing portion is a closed configuration,
the controller configuring the plurality of light shutter portions to display an image when the movable housing portion is in the opened configuration.

13. The device of claim 1,
an image capture device including a lens focused on an image sensor communicably coupled to an image engine,
the controller configuring the plurality of light shutter portions to display a view finder aligned with an optical path of the lens when the movable housing portion is in the opened configuration.

14. The device of claim 1, an optical film disposed adjacent the plurality of light shutters on the movable housing portion, wherein an image viewable on the movable housing portion is not visible beyond a specified angle at which the image is projected through the optical film.
